(19) United States
(12) Patent Application Publication
(10) Pub. No.: US 2014/0195908 A1
(43) Pub. Date: Jul. 10, 2014

(54) UNIFORM VALUE HELP AND VALUE CHECK

(71) Applicants: Frank Brunswig, Heidelberg (DE); Olaf Duevel, Mannheim (DE); Bare Said, Sankt Leon-Rot (DE)

(72) Inventors: Frank Brunswig, Heidelberg (DE); Olaf Duevel, Mannheim (DE); Bare Said, Sankt Leon-Rot (DE)

(21) Appl. No.: 13/735,976

(22) Filed: Jan. 7, 2013

(51) Int. Cl. G06F 3/0481

(52) U.S. Cl. CPC G06F 3/0481
USPC 715/708

(57) ABSTRACT

In one aspect, there is provided a method for value help and check. The method may include receiving an indication associated with a user interface element, the indication representing a value help request for the user interface element; sending a request for a value help to a value help business object configured to provide the value help to a user interface including the user interface element, the user interface element bound to a portion of the value help business object; and receiving, at the user interface comprising the user interface element, a response to the request, the response comprising the value help. Related systems, methods, and articles of manufacture are also disclosed.

### TECHNICAL FIELD

The subject matter described herein relates generally to data processing.

### BACKGROUND

The inherent complexity of business scenarios, which can include one or more business processes, and their implementation in business software solutions, enterprise resource planning (ERP) systems and the like can present substantial challenges to users and can be a serious obstacle to widespread operative use of process and scenario models in the software landscape. Indeed, these complex business processes may include dozens, if not hundreds or more, steps, making it difficult for the end-user and the enterprise to manage. As such, business systems often provide value help to users of the business system. For example, when a user attempts to complete a form at a user interface, value help may provide additional information, such as permissible values for entry at the form, meta-information regarding the entries, and the like, and these entries may be presented proximate to where the value is to be entered.

### SUMMARY

In one aspect, there is provided a method. The method may include receiving an indication associated with a user interface element, the indication representing a value help request for the user interface element; sending a request for a value help to a value help business object configured to provide the value help to a user interface including the user interface element, the user interface element bound to a portion of the value help business object; and receiving, at the user interface comprising the user interface element, a response to the request, the response comprising the value help.

In some variations, one or more of the following features can optionally be included in any feasible combination. The value help business object may be configured to provide the value help and a value check for the user interface element, wherein the value help represents one or more candidate selections for entry into the user interface element, and the value check represents a verification of the one or more candidate selections. The user interface may be modeled by a business object. The user interface element may be bound by associating, via another user interface, the user interface element to the portion comprising a node of the value help business object. The value help business object may share metadata stored at a metadata repository with a business object modeled for the user interface. The shared metadata may include an identifier, a customer identifier, a product identifier, and a country code. The sending may include navigating, based on one or more associations, from the business object modeled and stored in the metadata repository to the value help business object modeled and stored in the same metadata repository.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts an example of a value help business object, in accordance with some example implementations;

FIG. 1B depicts an example of a user interface element providing value help, in accordance with some example implementations;

FIG. 2 depicts an example of a business object, in accordance with some example implementations;

FIG. 3 depicts an example of a process for value help provided by a value help business object, in accordance with some example implementations; and

FIG. 4 depicts another example of a process for value help provided by a value help business object, in accordance with some example implementations.

When practical, similar reference numbers denote similar structures, features, or elements.

### DETAILED DESCRIPTION

Value help may be used to provide additional information to a user interface. For example, when a user is completing a form, value help may be invoked to provide additional information regarding an identifier associated with the form, check values input into the form, and the like. For example, a sales order form may require entry of a technical identifier representative of a specific contact at a customer location. The entry of code 01 at the form presented at a user interface may correspond to a certain entity, and entry of code 02 may corresponds to another entity. As a user entering these technical identifiers at a user interface is unlikely to remember these codes, value help may be used to assist the user by providing additional information (e.g., in a user interface or view) mapping the codes to, for example, names of the entities. The value help may also be used to check entries (e.g., whether the entry is permissible, of the proper form, and the like).

When a user interface is developed, the user interface elements (also referred to as fields) may be hard coded to have a type defining a specific query required to obtain the value help. However, these specific queries are complex, requiring an understanding of the query language, and vary tremendously based on the type of value help, the underlying source of the data for the value help, and the like.

The subject matter described herein may, in some example implementations, provide a business object configured to provide value help (referred to as “value help business object” and/or “value help and check business object”).

In some example implementations, a value help business object (which may include value checking) may be provided. When the value help business object is instantiated, a service provider is formed that can return value help, including value checking, to a user interface. Referring to the previous example of the entry codes, the user interface element where the codes are entered may be bound to a value help business object (or a node therein), rather than specifying a specific, hard-coded query. The use of the value help business object may thus simplify user interface implementation as the user interface element within the context of a given user interface may be bound to the value help business object (or portion thereof), rather than requiring coding of a specific query for the user interface element.

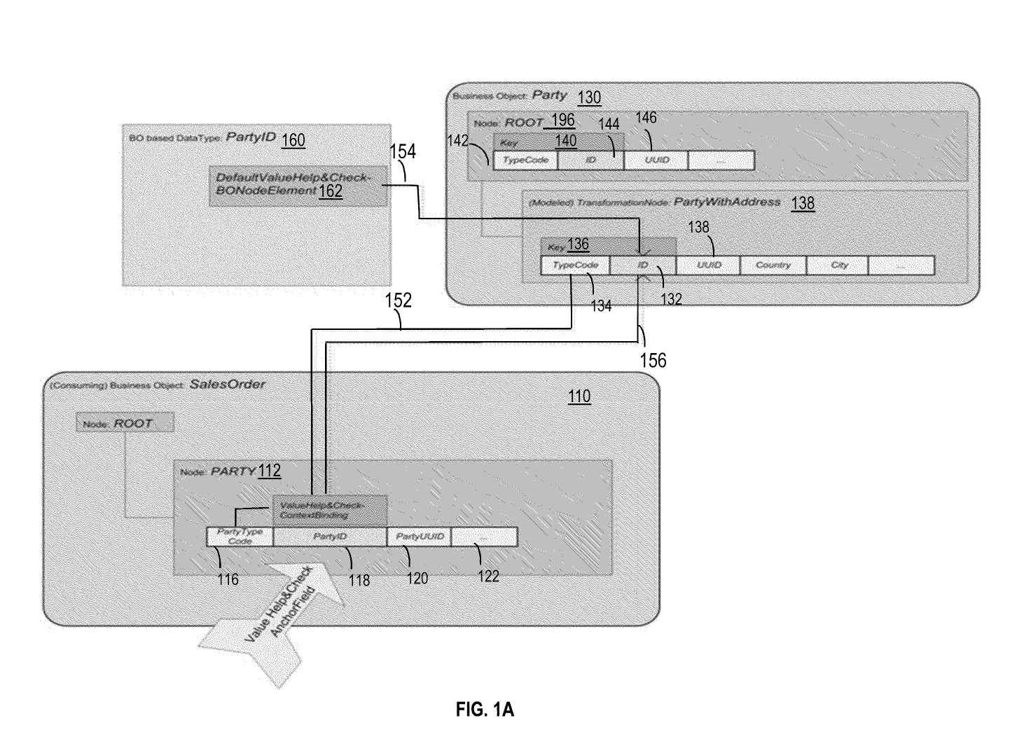

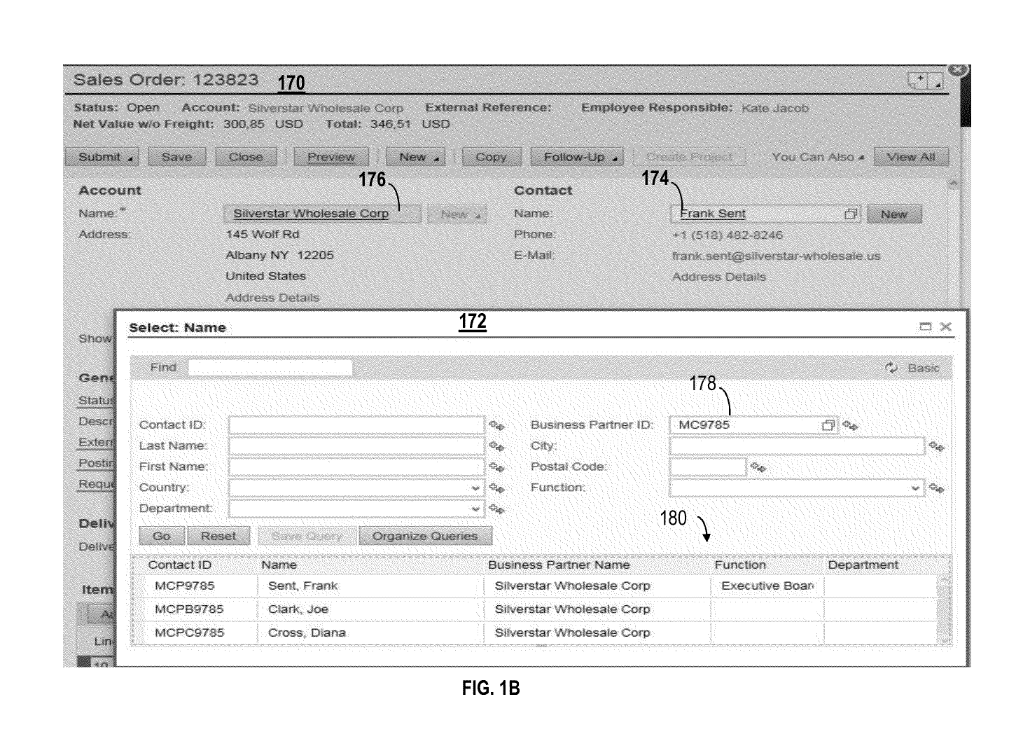

FIG. 1A depicts an example of a value help business object bound to a user interface element. In the example of FIG. 1A, the user interface element for a party identifier is bound, so that value help is obtained via a node, such as a value help business object node 162 (labeled default value help and check business object node element). For example, when the user interface element for the party identifier is modeled during development of the user interface, the user interface element is bound via an association linking the user interface element with at least party identifier 118, which is further bound to type code 134 and identifier 132 at the business object for the party (party business object). And, a key 136 based on at least the type code 134 and identifier 132 is then bound to the value help business object 160 including default value help and check business object node element 162. This binding can be done via a user interface by making the noted associations 152-156 (e.g., defining the links between party identifier 118 and type code 134/identifier 132 via links 152-156 and the like).

In the example of FIG. 1A, business object 110 represents a consuming business object having nodes, such as a root node 112 and a party node 114. This consuming business object represents the business object providing information for a sales order form viewed at a user interface including one or more user interface elements, where value help is being requested and presented. The party node 112 includes information (e.g., data and/or actions) associated with a party to a sales order. In the example of FIG. 1A, the party node 112 includes a party type code 116, a party identifier 118, and a party universally unique identifier (UUID) 120, and any other information 122.

A portion of the business object, such as party identifier 118, may serve as a so-called “anchor field” (or element) bound to default value help and check business object node element 162. For example, a user interface element where value help is sought is bound to party identifier 118, so that when a user seeks value help on a user interface element presenting party identifiers, value help is returned by default value help and check business object node element 162 to the user interface. To that end, the party identifier 118 associates 152 and/or 156 (e.g., links) the sales order business object 110 to another business object, such as a party business object 130 to form a binding to a key 136, such as an identifier 132, a type code 134, and/or the UUID 138. In the example of FIG. 1A, the key 136 is also associated 154 to the value help business object including value help and check business object node element 162.

The party business object 130 may further include one or more nodes, such as a root node 196 and a modeled transformation node 138. The root node 196 includes key 140 comprising the type code 142, identifier 144, and UUID 146, and the like, and the key 140 links to node 138 at key 136. Node 138 may map an identifier 132 into additional metadata, such as a country, a city, and other address information associated with the party corresponding to identifier 132. In the example of FIG. 1A, the modeled transformation node 138 maps the party identifier 118 into additional metadata including context information, such a country, city, and the like which can be used by value help and check business object node element 162 to generate the value help.

FIG. 1B depicts a user interface 170 presenting a sales order and a second user interface 172 providing value help and check for user interface element contact “Name” 174. Specifically, when value help is requested for Name 174 at user interface 170, the business partner identifier 178 (e.g., “MC9785”) for Silverstar Wholesale Corp. 176 is used to obtain value help and check for permissible (e.g., checked) contacts at Silverstar Wholesale Corp. In the example of FIG. 1B, user interface 172 includes value help 180 in the form of a view of permissible contact names (e.g., “Sent, Frank,” “Clark, Joe,” and “Cross, Diana”). When one of these contact names is selected at the user interface 172, the selected name is inserted in the user interface element 174 as shown.

Referring again to FIG. 1A and the previous example of FIG. 1B, the business partner identifier 178 serves as the anchor field at 118 bound via associations 152-156 to enable a service provider, including the value help and check business object 160 and the value help and check business object node element 162, to return the value help 180 to the user interface 172.

Although some of the examples disclosed herein refer to specific types of forms, value help and check, and business objects, these are merely examples as other types of forms, value help and check, business objects, and the like, may be used as well.

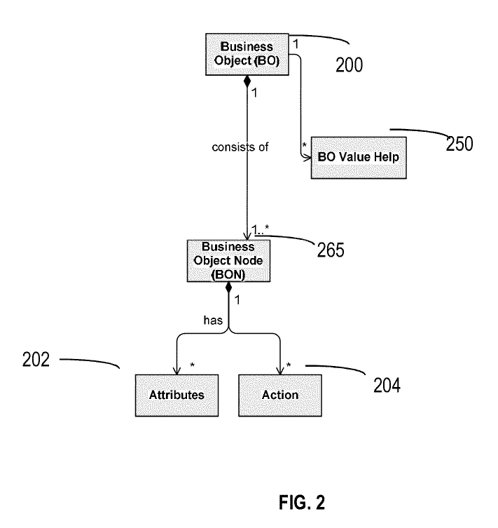

Before providing additional details, FIG. 2 depicts an example of a business object. The business object (BO) 200 comprises a root node (labeled business object node 165), data content (e.g., attributes) 202, and processes (e.g., actions) 204. The business object 200 may be used to structure an object in terms of a real world business task. For example, a business object may comprise an object including data and processes for a sales order, another business object may include data and processes for a purchase order, and yet another business object may provide customer relationship data, and so forth. And, these business objects may be linked (e.g., associated), and these links may be stored in metadata. The metadata of business object 200 may include one or more of fields, nodes, actions, associations, and business logic, and this metadata may be stored in a repository, such as a metadata repository (MDRS).

In some example implementations, business object 200 may be associated with a value help business object 250. This value help business object 250 may be instantiated at a service provider, which when called provides value help and check as described herein. Moreover, the metadata of business object 250 may also include one or more of fields, nodes, queries, actions, and business logic, and this metadata may be stored in a repository, such as a metadata repository (MDRS). Moreover, the business object 200 and the value help business object 250 may, in some implementations, utilize the same framework, such as the metadata object model and runtime engine.

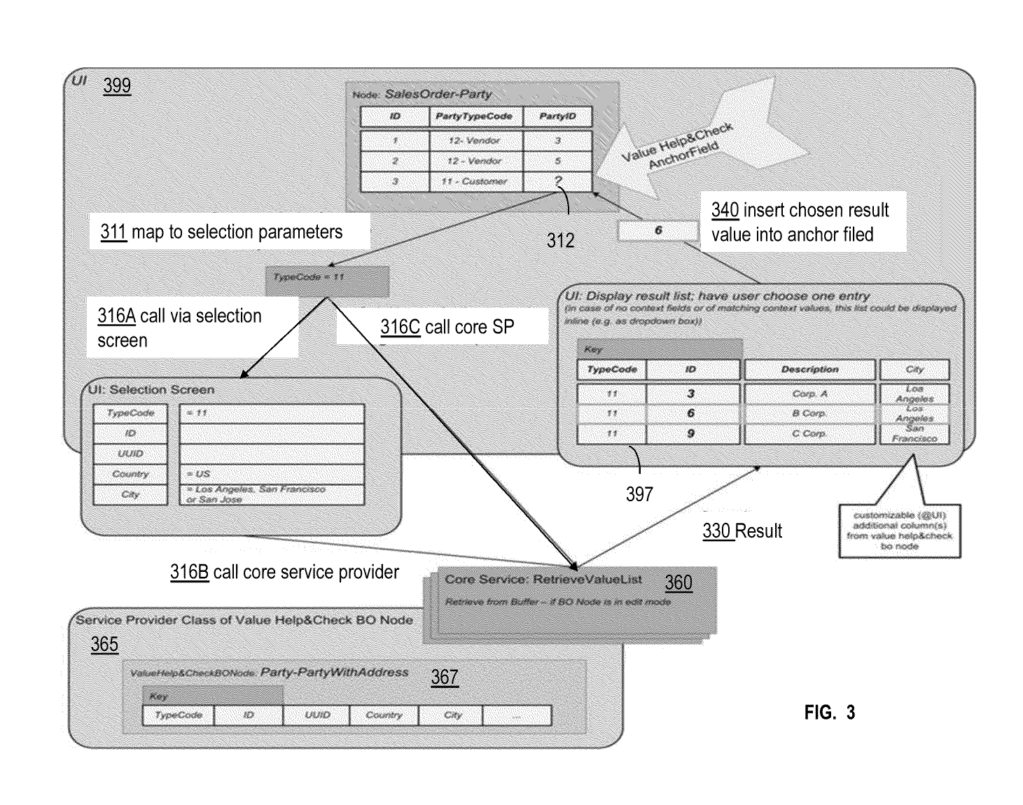

FIG. 3 depicts a runtime example of a user interface element receiving value help via a value help business object. The description of FIG. 3 also refers to FIG. 1A.

The value help may include screen selection in which value help is made based on a screen, or the value help may not include screen selection. In any case, a developer of a user interface 399 may specify value help for a user interface element, and the value help may correspond to party identifier 312, which corresponds to party identifier at 118 bound as noted with respect to FIG. 1A.

In the example of FIG. 3, value help for the user interface element of “Party ID” 312 is sought. When this is the case, the party identifier (ID) 312 serves as the anchor field bound to a value help business object.

At 311, the user interface 399 may map the context values to selection parameters for the value help and check business object 160. In the example of FIG. 3, the context values correspond to the context, such as ID 3 and Party Type Code, 11, and these context values are mapped into selection parameters for a call to the service provider including the value help and check business object 160. Specifically, the party type code in this example is 11, which is used as a selection parameter as shown at 311, and the service provider is called as a core service as “Retrieve Code List,” as described further below.

At 316C, the user interface 399 makes a call to the service provider including the value help and check business object. In the example of FIG. 3, the service provider is called as the core service “Retrieve Value List.” This core service 360 retrieves from the value help and check business object node 365 value help information based on the selection parameters, such as type code is 11. This retrieval may be from a buffer including the value help information or non-buffered values as well.

At 316A-B, the user interface 399 makes a call to the service provider including the value help and check business object. Unlike 316C, the call is made, however, via screen selection 392. For example, screen 392 is presented mapping the selection parameters, which can be modified via a selection at the screen 392 user interface. Once accepted, the selection parameters, such as type code 11, a country value, and/or a city value are used as call parameters in a call made at 316B to the core service “Retrieve Value List” in order to obtain value help.

At 330, a result is provided by the core service “Retrieve Value List.” In the example of FIG. 3, the result includes the values presented at 397. Specifically, the value help parameters include type code 11, identifiers, descriptions, and cities, so a selection at 397, results into value help being chosen for insertion at 340 into 312.

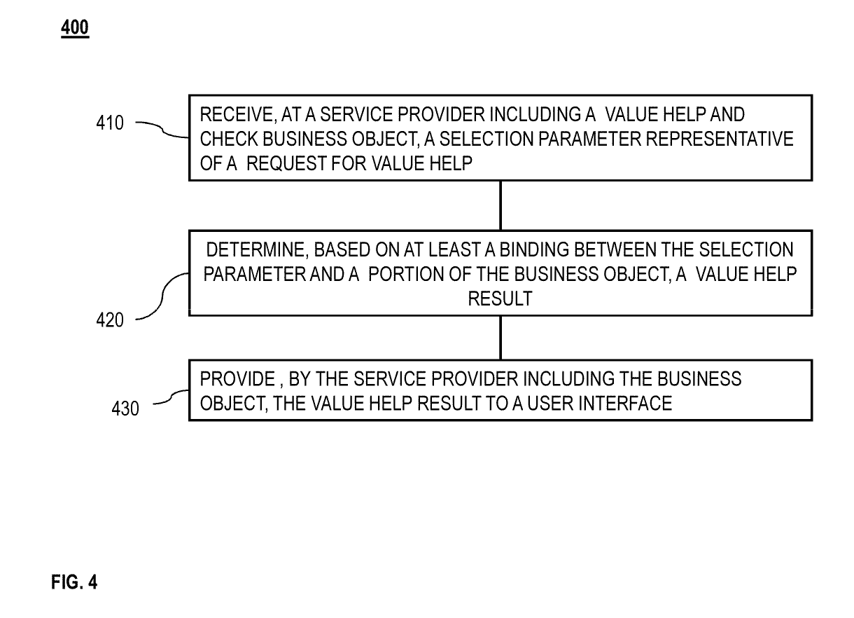

FIG. 4 depicts an example process 400 for value help. The description of FIG. 4 also refers to FIGS. 1A-1B and 3.

At 410, an indication is received. The indication may be associated with a user interface element and represent a value help and check request for the user interface element. For example, when value help and check is requested for contact name 174, an indication is received at the user interface representing a request for value help for the user interface element of contact name 174.

At 420, a request is sent to the value help business object configured to provide the value help to a user interface including the user interface element bound to a portion of the value help business object. For example, the user interface may make a call to service provider 365 including the value help business object as described above with respect to 316A-C to obtain value help and check for the user interface element.

At 430, the user interface including the user interface element receives a response to the request, the response comprising the value help (which as noted may also include a check). For example, the user interface may receive a value help result, such as the result 330 or 312 described above with respect to FIG. 3.

In some example implementations, the value help (e.g., provisioning of a relevant set of values for a user interface) and the check (e.g., validating a value help selected for use at the user interface) may, as noted above, be provided by a single value help business object. Using a single value help business object for value help and check may result in a common based of metadata, such as identifiers, customer identifiers, product identifiers, country codes, region codes, and the like, for a business system. And, a business object representing master data (which can be shared by a plurality of entities) and/or configuration data (e.g., customer identifiers, product identifiers, country codes, region codes) may be modeled to provide a value help business object based on an assignment as type value help business object type.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-readable storage medium storing one or more programs, the one or more programs having instructions which when executed by at least one programmable processor, cause the at least one programmable processor to perform operations comprising:
receiving an indication associated with a user interface element, the indication representing a value help request for the user interface element;
sending a request for a value help to a value help business object configured to provide the value help to a user interface including the user interface element, the user interface element bound to a portion of the value help business object; and
receiving, at the user interface comprising the user interface element, a response to the request, the response comprising the value help.

2. The computer-readable medium of claim 1, wherein the value help business object is configured to provide the value help and a value check for the user interface element, wherein the value help represents one or more candidate selections for entry into the user interface element, and the value check represents a verification of the one or more candidate selections.

3. The computer-readable medium of claim 1, wherein the user interface element is bound by associating, via another user interface, the user interface element to the portion comprising a node of the value help business object.

4. The computer-readable medium of claim 1, wherein the user interface is modeled by a business object.

5. The computer-readable medium of claim 4, wherein the value help business object shares metadata stored at a metadata repository with the business object modeled for the user interface.

6. The computer-readable medium of claim 5, wherein the shared metadata includes an identifier, a customer identifier, a product identifier, and a country code.

7. The computer-readable medium of claim 5, wherein sending the request comprises:
navigating, based on one or more associations, from the business object modeled and stored in the metadata repository to the value help business object modeled and stored in the same metadata repository.

8. A method comprising:
receiving an indication associated with a user interface element, the indication representing a value help request for the user interface element;
sending a request for a value help to a value help business object configured to provide the value help to a user interface including the user interface element, the user interface element bound to a portion of the value help business object; and
receiving, at the user interface comprising the user interface element, a response to the request, the response comprising the value help.

9. The method of claim 8, wherein the value help business object is configured to provide the value help and a value check for the user interface element, wherein the value help represents one or more candidate selections for entry into the user interface element, and the value check represents a verification of the one or more candidate selections.

10. The method of claim 8, wherein the user interface element is bound by associating, via another user interface, the user interface element to the portion comprising a node of the value help business object.

11. The method of claim 8, wherein the user interface is modeled by a business object.

12. The method of claim 11, wherein the value help business object shares metadata stored at a metadata repository with the business object modeled for the user interface.

13. The method of claim 12, wherein the shared metadata includes an identifier, a customer identifier, a product identifier, and a country code.

14. The method of claim 12, wherein sending the request comprises:
navigating, based on one or more associations, from the business object modeled and stored in the metadata repository to the value help business object modeled and stored in the same metadata repository.

15. A system comprising:
at least one processor; and
at least one memory including code that, when executed by at least one programmable processor, causes operations comprising:
receiving an indication associated with a user interface element, the indication representing a value help request for the user interface element;
sending a request for a value help to a value help business object configured to provide the value help to a user interface including the user interface element, the user interface element bound to a portion of the value help business object; and
receiving, at the user interface comprising the user interface element, a response to the request, the response comprising the value help.

16. The system of claim 15, wherein the value help business object is configured to provide the value help and a value check for the user interface element, wherein the value help represents one or more candidate selections for entry into the user interface element, and the value check represents a verification of the one or more candidate selections.

17. The system of claim 15, wherein the user interface element is bound by associating, via another user interface, the user interface element to the portion comprising a node of the value help business object.

18. The system of claim 15, wherein the user interface is modeled by a business object.

19. The system of claim 18, wherein the value help business object shares metadata stored at a metadata repository with the business object modeled for the user interface.

20. The system of claim 19, wherein the shared metadata includes an identifier, a customer identifier, a product identifier, and a country code.
